(19) United States
(12) Patent Application Publication
(10) Pub. No.: US 2025/0189830 A1
(43) Pub. Date: Jun. 12, 2025

(54) ALUMINUM SCANDIUM NITRIDE (ALSCN) BASED ELECTRO-OPTICAL MODULATOR

(71) Applicant: QUALCOMM Incorporated, San Diego, CA (US)

(72) Inventor: Willi AIGNER, Moosinning (DE)

(21) Appl. No.: 18/678,866

(22) Filed: May 30, 2024

Related U.S. Application Data
(60) Provisional application No. 63/609,205, filed on Dec. 12, 2023.

(51) Int. Cl. G02F 1/01

(52) U.S. Cl. CPC G02F 1/0113; G02F 1/0121; G02F 2201/063; G02F 2201/12; G02F 2201/42; G02F 2202/10

(57) ABSTRACT

Systems and techniques are described herein for using aluminum scandium nitride based electro-optical modulators. For example, a device or apparatus can include an optical waveguide comprising aluminum scandium nitride (AlScN) formed as part of a piezoelectric layer having an axis from a first side of the waveguide to a second side of the waveguide. The device or apparatus can further include an electrical signal line formed on the first side of the waveguide and a reference node formed on the second side of the waveguide.

### CROSS-REFERENCE TO RELATED APPLICATIONS

The present application claims the priority benefit of U.S. Provisional Patent Application No. 63/609,205 filed on Dec. 12, 2023 and titled “ALUMINUM SCANDIUM NITRIDE (ALSCN) BASED ELECTRO-OPTICAL MODULATOR”, the disclosure of which is hereby incorporated by reference in its entirety for all purposes.

### TECHNICAL FIELD

The present disclosure relates generally to electronics and integrated photonics communications. For example, aspects of the present disclosure relate to the use of aluminum scandium nitride based electro-optical modulators.

### BACKGROUND

Demands on communication systems and technologies are requiring ever more throughput with small form factor demands and cost pressures. Optical communications, particularly using optical waveguides, provide resistance to electromagnetic interference and lower attenuation over distance when compared with standard wired or wireless electrical or electromagnetic signals. Existing technologies to manage optical signals, however, are often significantly more complex and expensive than electrical and wireless technologies.

### SUMMARY

Aspects of the present disclosure describe electro-optical modulators using aluminum scandium nitride (AlScN) as both a waveguide material and a piezoelectric material used to modulate light in the waveguide made of the AlScN.

In some aspects, the techniques described herein relate to an apparatus including: an optical waveguide including a piezoelectric layer including aluminum scandium nitride (AlScN), the piezoelectric layer having an axis from a first side of the optical waveguide to a second side of the optical waveguide; an electrical signal line formed on the first side of the optical waveguide; and a reference node formed on the second side of the optical waveguide.

In some aspects, the techniques described herein relate to an apparatus, wherein the optical waveguide is disposed on a first silicon oxide (SiO2) layer, and wherein the reference node is disposed in the first SiO2 layer.

In some aspects, the techniques described herein relate to an apparatus, wherein the optical waveguide is a rib waveguide formed from the AlScN of the piezoelectric layer.

In some aspects, the techniques described herein relate to an apparatus, further including a second SiO2 layer disposed on the piezoelectric layer; wherein the electrical signal line is disposed on the second SiO2 layer.

In some aspects, the techniques described herein relate to an apparatus, further including a silicon substrate, wherein the first SiO2 layer is disposed on the silicon substrate.

In some aspects, the techniques described herein relate to an apparatus, further including an input waveguide disposed on the silicon substrate, wherein the input waveguide is positioned to overlap a first end of the optical waveguide for optical coupling from the input waveguide to the first end of the optical waveguide.

In some aspects, the techniques described herein relate to an apparatus, further including a light source having an output coupled to the input waveguide.

In some aspects, the techniques described herein relate to an apparatus, further including an output waveguide positioned to accept a modulated light signal from a second end of the optical waveguide.

In some aspects, the techniques described herein relate to an apparatus, further including: signal generation circuitry coupled to the electrical signal line; and a memory and one or more processors coupled to the memory, wherein the one or more processors are configured to provide data from the memory to the signal generation circuitry.

In some aspects, the techniques described herein relate to an apparatus, wherein the signal generation circuitry is configured to provide an electrical signal modulated at radio frequencies or microwave frequencies for modulation of light in the optical waveguide.

In some aspects, the techniques described herein relate to an apparatus, wherein the optical waveguide is a ridge waveguide formed from the AlScN of the piezoelectric layer.

In some aspects, the techniques described herein relate to an apparatus, further including a second SiO2 layer disposed on the piezoelectric layer and the first SiO2 layer.

In some aspects, the techniques described herein relate to an apparatus, wherein the ridge waveguide is a trapezoidal waveguide formed in the first SiO2 layer.

In some aspects, the techniques described herein relate to an apparatus, further including a silicon substrate, wherein the first SiO2 layer is disposed on the silicon substrate.

In some aspects, the techniques described herein relate to an apparatus, further including a tapered input waveguide disposed on the silicon substrate, wherein the tapered input waveguide is positioned to overlap a first end of the optical waveguide for optical coupling from the tapered input waveguide to the first end of the optical waveguide.

In some aspects, the techniques described herein relate to an apparatus, further including a light source having an output coupled to the tapered input waveguide.

In some aspects, the techniques described herein relate to an apparatus including: an aluminum scandium nitride (AlScN) piezoelectric waveguide having a c-axis; an electrical signal line formed on a first side of the AlScN piezoelectric waveguide; and a reference node formed on a second side of the AlScN piezoelectric waveguide; wherein the c-axis is aligned from the electrical signal line to the reference node.

In some aspects, the techniques described herein relate to an apparatus, further including signal generation circuitry coupled to the electrical signal line.

In some aspects, the techniques described herein relate to a method of fabricating an electro-optical modulator including: forming a first conductive line; forming an aluminum scandium nitride (AlScN) piezoelectric waveguide, wherein the first conductive line is on a first side of the AlScN piezoelectric waveguide, and wherein the AlScN piezoelectric waveguide has a c-axis; and forming a second conductive line on a second side of the AlScN piezoelectric waveguide, wherein the first conductive line, the second conductive line, and the AlScN piezoelectric waveguide are positioned such that the c-axis is aligned to be parallel with an electrical field generated by an electrical potential between the first conductive line and the second conductive line. In some aspects, the techniques described herein relate to a method, wherein the AlScN piezoelectric waveguide is formed of a layer including Al(1−x)Sc(x)N, where x=0.01*n, and n is a real numberfrom 0 through 45, inclusive.

### BRIEF DESCRIPTION OF THE DRAWINGS

Illustrative examples of the present application are described in detail below with reference to the following figures:

FIG. 1 is a diagram illustrating an example of an apparatus including an electro-optical modulator in accordance with aspects described herein;

FIG. 2A is a diagram illustrating aspects of an implementation of an electro-optical modulator in accordance with aspects described herein;

FIG. 2B is an isometric view of one implementation of an electro-optical modulator in accordance with aspects described herein;

FIG. 2C is an isometric view of one implementation of an electro-optical modulator in accordance with aspects described herein;

FIG. 2D is a diagram illustrating aspects of an implementation of an electro-optical modulator in accordance with aspects described herein;

FIG. 2E is an isometric view of one implementation of an electro-optical modulator in accordance with aspects described herein;

FIG. 2F is an isometric view of one implementation of an electro-optical modulator in accordance with aspects described herein;

FIG. 3A is an isometric perspective of aspects of an optical interconnect between a light source and an electro-optical modulator in accordance with aspects described herein;

FIG. 3B is an top-down perspective of aspects of an optical interconnect between a light source and an electro-optical modulator in accordance with aspects described herein;

FIG. 3C is a side-view perspective of aspects of an optical interconnect between a light source and an electro-optical modulator in accordance with aspects described herein;

FIG. 4 is a flow diagram illustrating aspects of a method of manufacturing an electro-optical modulator in accordance with aspects described herein;

FIG. 5 is a block diagram illustrating an example computing-device architecture of an example computing device which can include one or more implementations of an electro-optical modulator in accordance with aspects described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be implemented and/or practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Aspects described herein include electro-optical modulators used to modulate light in a waveguide to encode data on the light for the purpose of communicating an optical signal. The electro-optical modulators described herein use aluminum scandium nitride (AlScN) as a piezoelectric waveguide material. When an electromagnetic field is applied across the AlScN waveguide area, the light in the AlScN waveguide is modulated based on the applied electrical field. Such an applied electromagnetic field can operate at radio frequencies (Rf) and microwave frequencies, allowing encoding of Rf and/or microwave signals onto light within the waveguide of an electro-optical modulator. The modulated light can then be output as an optical signal for transmission.

Existing bulk electro-optical modulators include lithium niobate (LiNbO₃ or LN) based piezoelectric modulators. Such LN based electro-optical modulators are often used due to the large electro-optical coefficient r33 in the z-axis direction that is possible with an LN piezoelectric layer. Such devices, however, are manufactured using titanium (Ti)-interdiffusion with a complex process needed to achieve the desired axis in an integrated device. Additionally, such devices are relatively large (e.g., approximately 10 centimeters along the modulation waveguide length,) use a driving voltage that is high relative to typical electrical device voltages, and have low optical waveguide mode confinement, resulting in signal losses and/or poor signal quality. An electro-optic coefficient r33 of LiNbO₃ (all fields in z-direction) is about 30 pm/V. Al(1−x)Sc(x)N with 0.3<x<0.45 can exhibit an r33 at least similar to LiNbO3. In some aspects herein, AlScN has a performance of 20pm/V <r33 <60pm/V for Al(1−x)Sc(x)N with 0.3<x<0.45.

Additionally, the fabrication processes described above to achieve the piezoelectric orientation, as complex processes noted above, can include expensive wafer grinding or cutting operations, along with challenges structuring the waveguide within the piezoelectric LN material. Such challenges can include additional processes for smoothing LN waveguide edges after grinding, etching, or cutting, as a surface roughness results in additional signal losses.

AlScN as a piezoelectric layer in electro-optical modulators provides a number of benefits over prior modulators using piezoelectric materials such as LN. In particular, AlScN can be used as a piezoelectric material with the piezo axis (e.g., particularly the c-axis as described below) as-grown or fabricated, without the need for grinding or cutting to adjust the piezo axis. Thus, while AlScN is a wurtzite structure where piezo axis rotation is not easily possible (e.g., compared with LN, where rotation is possible, but at a cost of complexity and cost), this issue with AlScN does not pose a problem where the as-grown piezo axis of an AlScN layer can be used. Such an AlScN piezoelectric layer can be grown at a high quality with up to 45% scandium using physical vapor deposition (PVD) and/or pulsed laser deposition (PLD). In various aspects, the AlScN can be described as Al(1−x)Sc(x)N, where x=0.01*n. In some cases, the term n can be any (real) number from 0 through 45, inclusive, and the term x can include multiples of 0.01, such as from 0 through 45 (e.g., to cover all possible AlScN compositions 0.0≤x≤0.45, with 0 being the material AlN (e.g., with the Sc aspect 0 or not present in the material).

The resulting piezoelectric layer of AlScN provides piezoelectric coupling and electro-optical coefficient performance similar to LN piezoelectric layers without the need for complex fabrication cutting, grinding, and polishing used with LN piezoelectric layer fabrication. AlScN electro-optical modulators as described herein can thus improve device performance by providing similar high-speed and high-efficiency optical modulation using a more efficient manufacturing process. Some implementations can provide an additional benefit with a greater electro-optical effect that LN devices, providing device improvement via a higher modulation efficiency. Additionally, layer etching processes available for use with AlScN waveguides can provide lower losses than comparable LN waveguides, using existing materials and processes for fabrication of AlScN electro-optical modulators in integrated photonic devices.

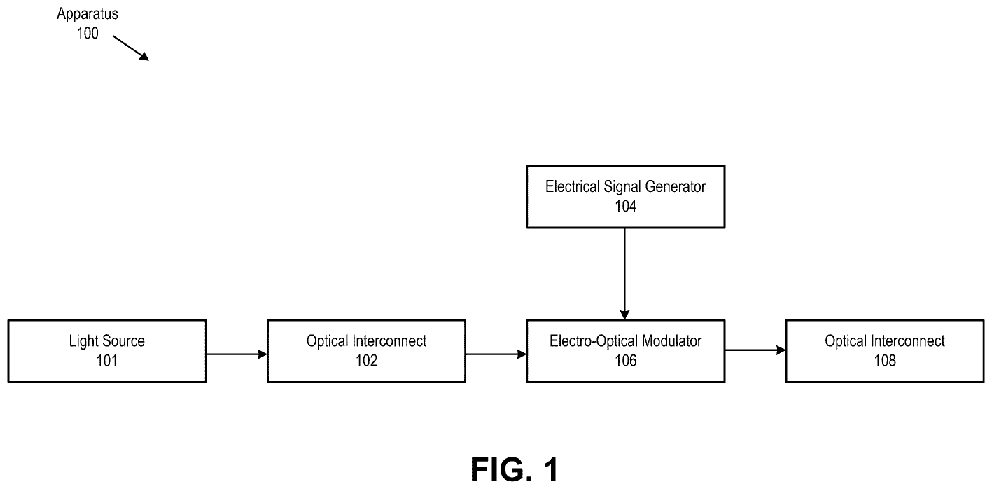

FIG. 1 is a diagram illustrating an example of an apparatus 100 including an electro-optical modulator 106 in accordance with aspects described herein. The apparatus, in addition to the electro-optical modulator 106, includes a light source 101, an optical interconnect 102 coupling the light source 101 to the electro-optical modulator 106, an output optical interconnect 108 at an output of the electro-optical modulator 106, and electrical signal generator 104 coupled to the electro-optical modulator.

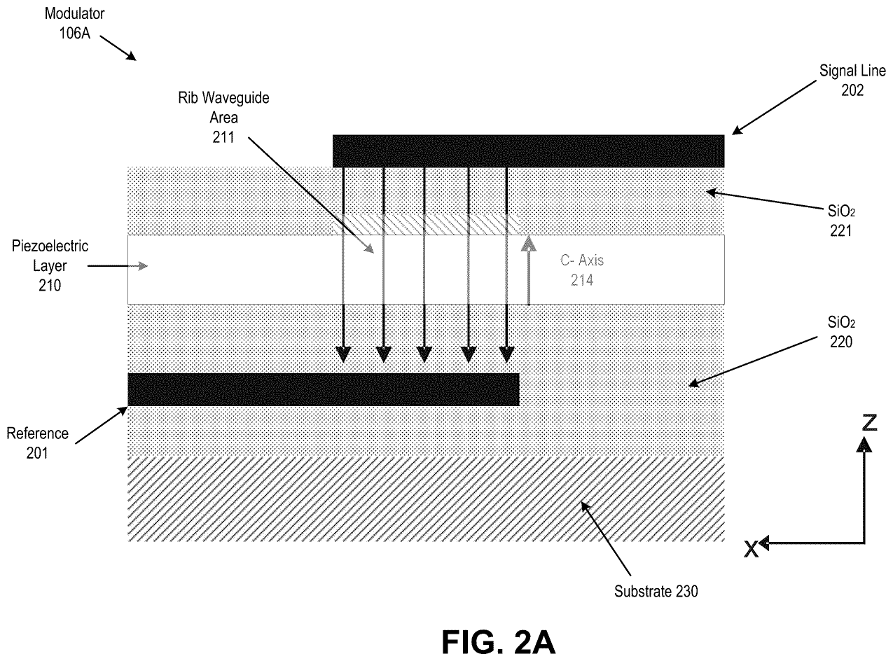

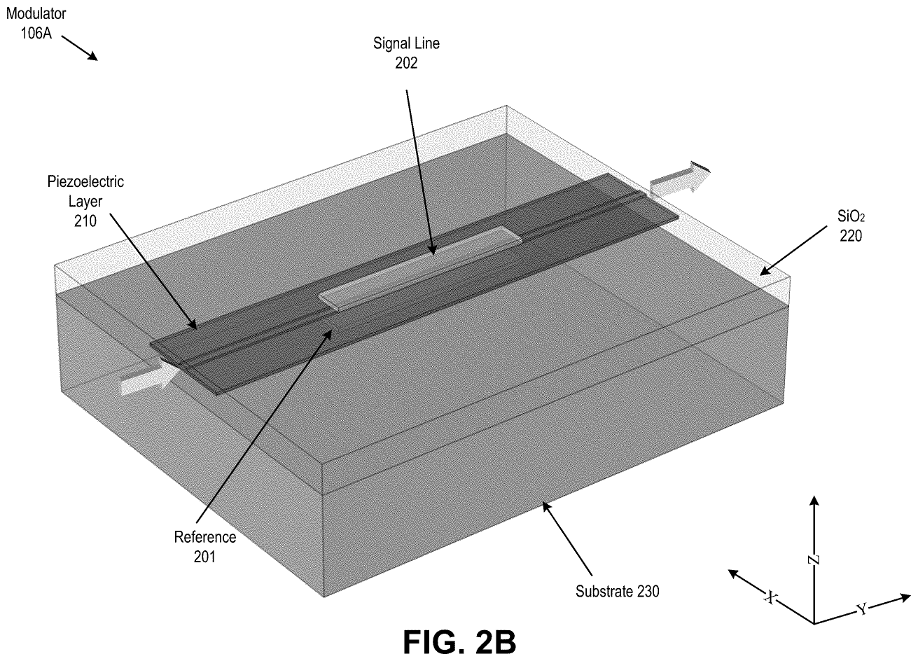

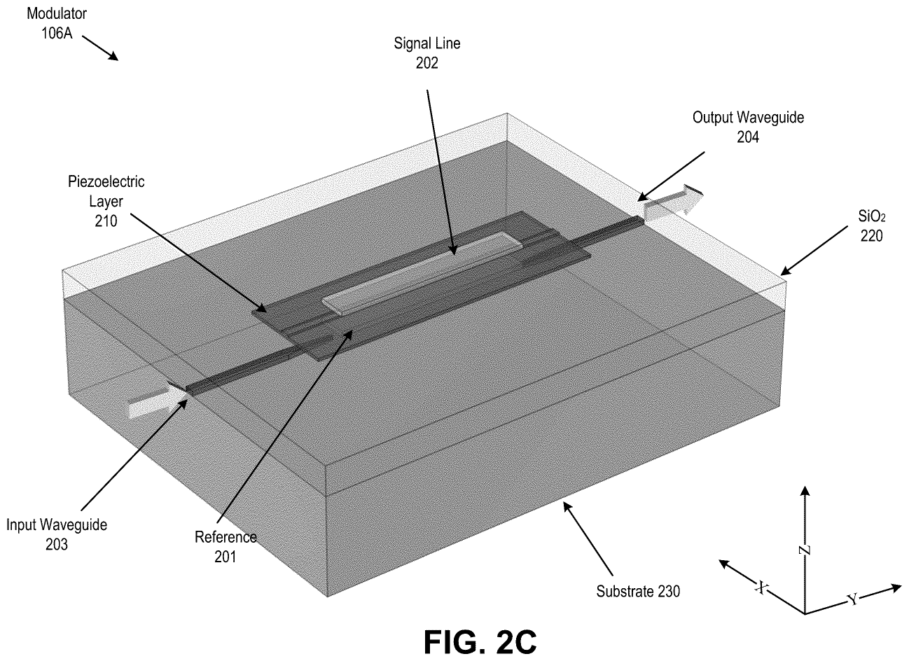

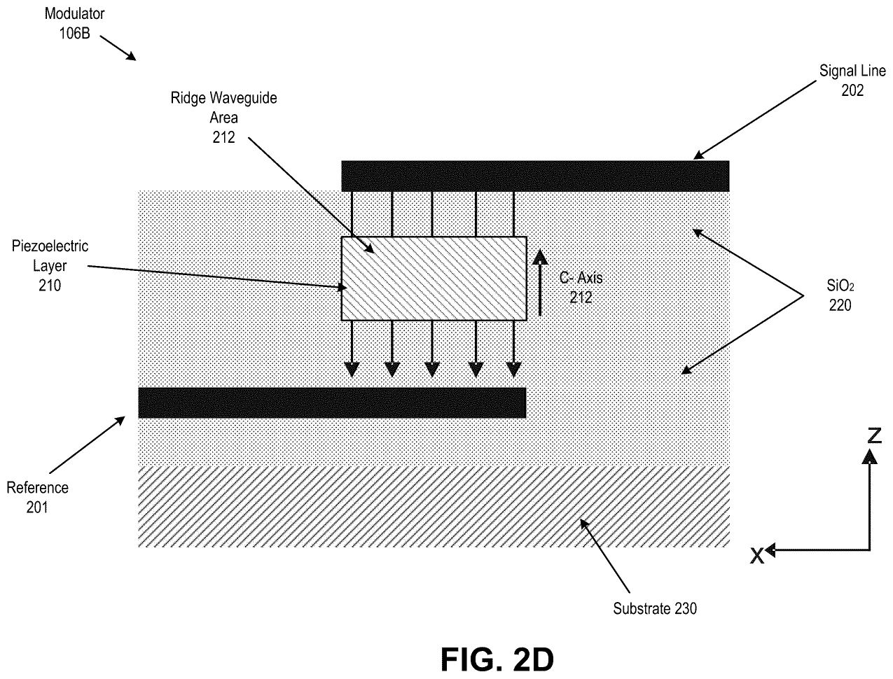

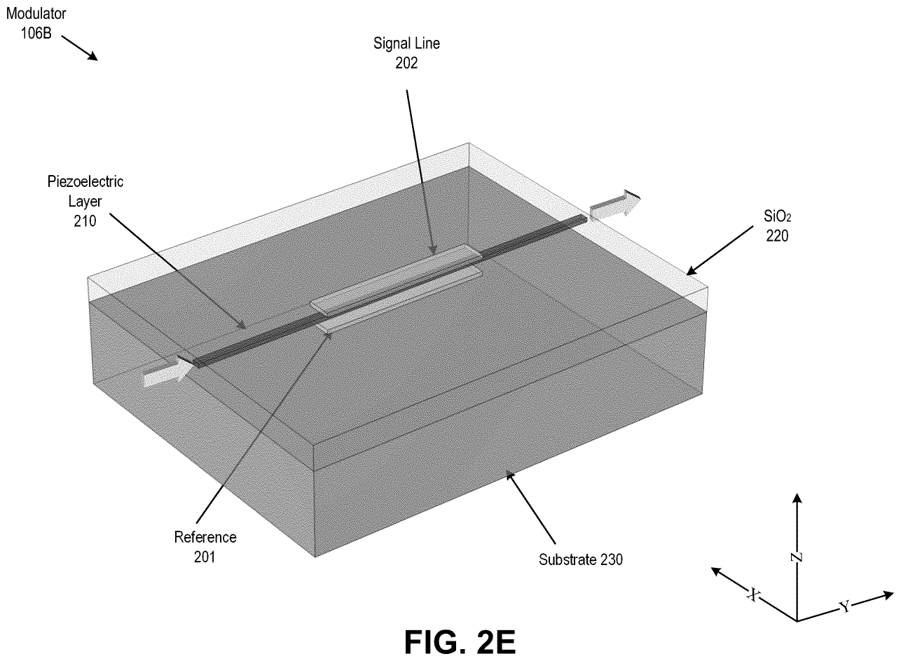

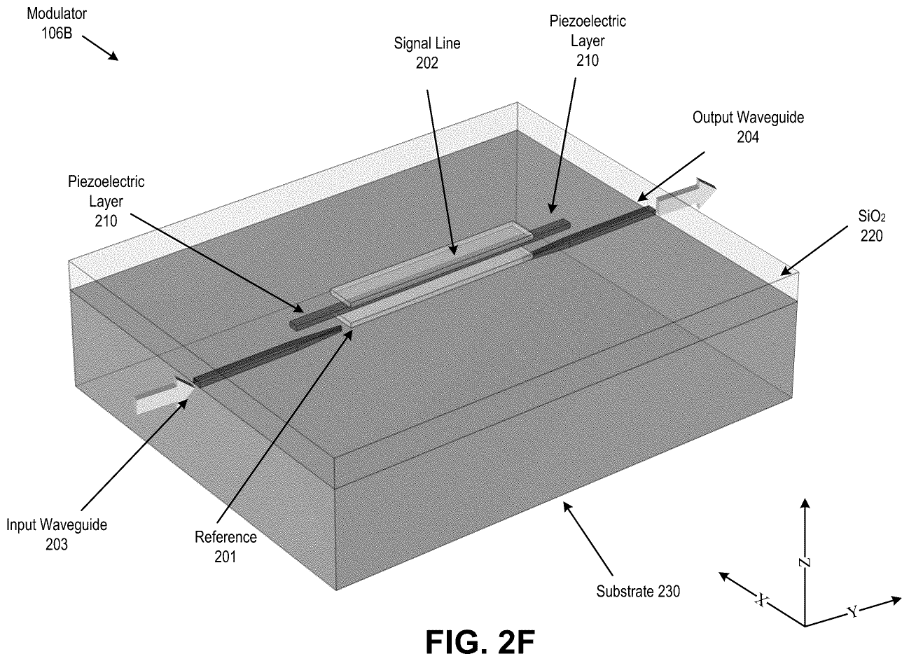

The light source 101 is a continuous wave (CW) light source that provides input light to the electro-optical modulator 106 to be modulated. The optical interconnects 102 and 108 can be structures for coupling light between waveguides of different materials (e.g., a piezoelectric waveguide of the electro-optical modulator and silicon or other waveguides associated with the light source 101 and/or a transmission media, such as an optical fiber). The electrical signal generator 104 can be communication circuitry configured to upconvert data from control circuitry (e.g., from memory or other data sources of a computing apparatus) to Rf or microwave frequencies. The electrical signal generator 104 can be coupled to a signal waveguide of the electro-optical modulator 106, as illustrated in additional detail below in FIGS. 2A and 2D. As described above, in accordance with aspects herein, the electro-optical modulator 106 is a device configured to modulate light signals using an AlScN piezoelectric waveguide using an electromagnetic field generated between a signal input (e.g., a signal waveguide) and a reference node (e.g., a ground node) across the AlScN piezoelectric waveguide.

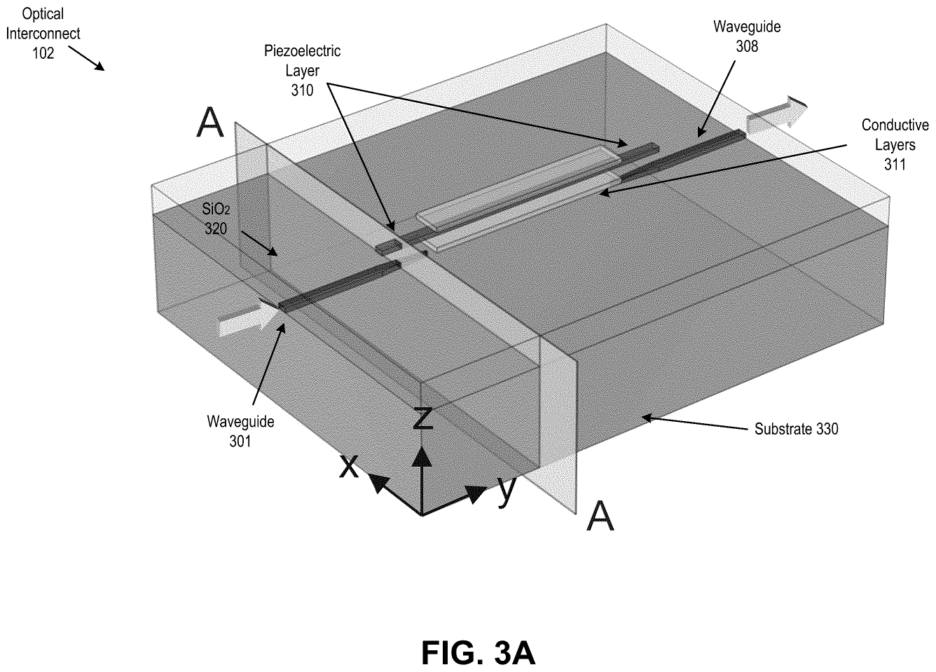

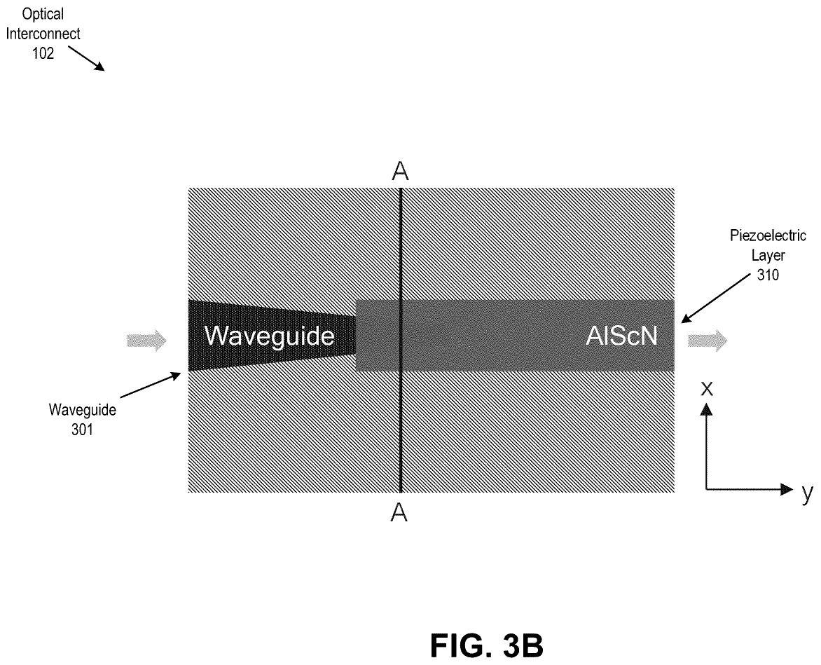

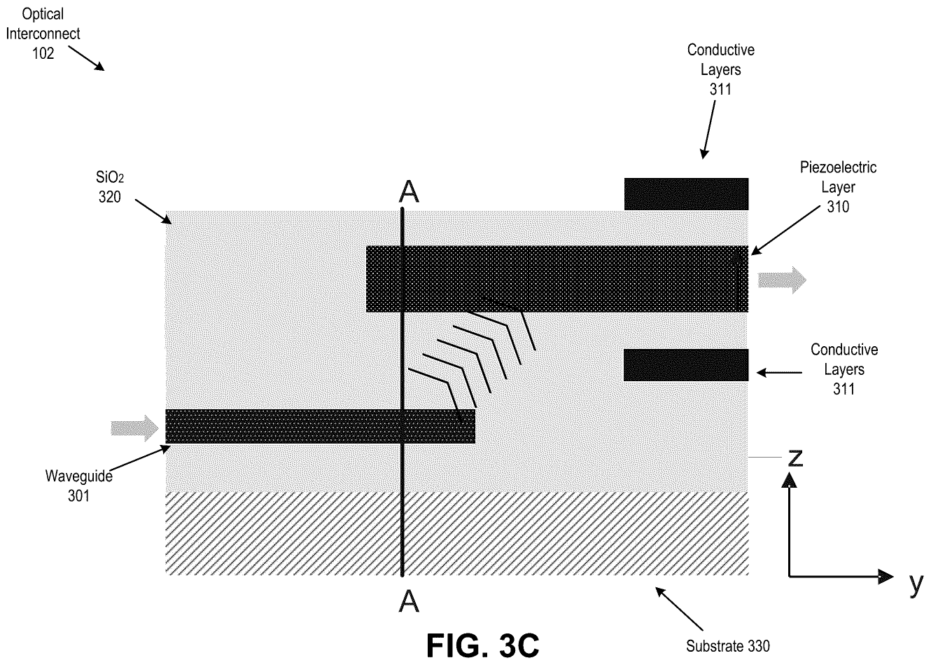

FIG. 2A is a diagram illustrating aspects of an implementation 106A of the electro-optical modulator 106 in accordance with aspects described herein. FIG. 2A shows an electro-optical modulator from a cross-section perspective, looking along a line of a waveguide that will extend away from the view and toward the view of FIG. 2A (e.g., along cross sections similar to the cross sections shown in the isometric view of FIG. 3A). FIGS. 2B and 2C show the implementation 106A in isometric perspective when implemented with optical interconnects to input waveguide 203 and output waveguide 204 (e.g., FIG. 2C) and without optical interconnects (e.g., FIG. 2B). Additional details associated with optical interconnects in accordance with some aspects are described in FIGS. 3A-3C below. The implementation 106A of FIG. 2A includes an AlScN piezoelectric layer 210 with a rib waveguide area 211. The piezoelectric layer 210 is surrounded by silicon oxide (SiO₂), with a first supporting SiO₂ layer 220 formed on a silicon substrate 230, and a second covering SiO₂ layer 221 disposed over the AlScN piezoelectric layer 210. A reference 201 node is formed in the lower portion of the SiO₂ layer 220, and a signal line 202 (e.g., a waveguide coupled to a signal source such as the electrical signal generator 104) is disposed in or on the upper portion of the SiO₂ layer 221. The signal line 202 and the reference 201 node can be any suitable conductive or metallization layer. As described above, the AlScN piezoelectric layer 210 can be grown on the lower SiO₂ layer 221 at a high quality with up to 45% scandium using physical vapor deposition (PVD) and/or pulsed laser deposition (PLD). As grown, the AlScN piezoelectric layer 210 has the illustrated axis 214, which allows a signal on the signal line 202 to modulate light in the rib waveguide area 211. In FIGS. 2A and 2D, the signal line 202 is shown on an opposite side of the substrate 230 from the piezoelectric layer 210, with the reference 201 between the substrate 230 and the piezoelectric layer 210. In other aspects, the positions of the signal line 202 and the reference 201 (e.g., the electrical connections to these conductive layers) can be reversed.

In accordance with aspects described herein, piezoelectric layers such as the AlScN piezoelectric layer 210 have a crystallographic orientation which can be referred to or described by the axis (e.g., the axis 214). The electro-optic effect in such materials occurs when an applied external electric field induces a material polarization in a material and/or direction where the amount of polarization depends on the external field. In the illustrated implementation 106A of the electro-optical modulator 106, the electrical field applied across the rib waveguide area 211 from the signal line 202 to the reference 201 with the axis 214 of the piezoelectric layer 210 as shown induces a polarization that modulates light in the rib waveguide area 211, resulting in a modulated optical modulation. As the AlScN main axis 214 is in the z-direction as illustrated, the signal line 202 and the reference 201 (e.g., ground) are configured to generate electric field lines normal to the piezoelectric layer 210 surface.

As described above, such an AlScN based electro-optical modulator includes benefits over previously known piezoelectric electro-optical modulators, due to a variety of reasons. The electro-optical coefficient (e.g., the electro-optical effect in AlScN) is greater than in prior devices (e.g., LN), allowing for smaller devices with similar modulation performance. Additionally, the direct-formation of the illustrated axis 214 orientation provides a benefit when compared with prior devices, where as-formed piezoelectric orientations are not appropriate for modulation, and are ground or cut to form the material for a piezoelectric layer in an electro-optical modulator (e.g., LN based devices). This direct formation of the AlScN piezoelectric layer 210 can additionally be used with simplified etching processes to form the rib waveguide area 211, avoiding complex smoothing operations to form LN waveguide edges after grinding, etching, or cutting (e.g., to limit surface roughness of LN as a surface roughness results in signal losses.) Similarly, as described above, an electro-optic coefficient r33 of LiNbO₃ (all fields in z-direction) is about 30 pm/V. Al(1−x)Sc(x)N with 0.3<x<0.45 can exhibit an r33 at least similar to LiNbO₃. In some aspects herein, AlScN has a performance of approximately 20 pm/V<r33<60 pm/V for Al(1−x)Sc(x)N with 0.3<x<0.45.

FIG. 2D is a diagram illustrating aspects of an implementation 106B of the electro-optical modulator 106 in accordance with aspects described herein. The implementation 106B of the electro-optical modulator 106 is similar to the implementation 106A of FIG. 2A, with a base substrate 230 (e.g., Si), but with the piezoelectric layer formed as a ridge waveguide area 212 surrounded by the SiO2 layer 220 instead of the rib waveguide area 211 with separate SiO₂ layers 220, 221. FIGS. 2E and 2F show the implementation 106B in isometric perspective when implemented with optical interconnects to the input waveguide 203 and the output waveguide 204 (e.g., FIG. 2F) and without optical interconnects (e.g., FIG. 2E). Additional details associated with optical interconnects in accordance with some aspects are described in FIGS. 3A-3C below. In some aspects, the ridge waveguide area is formed by formation of separate SiO2 layers 220, 221 to surround the piezoelectric layer 210 that forms the ridge waveguide area 212. The ridge waveguide area 212 is structured from the piezoelectric layer 210 as a rectangular waveguide surrounded by the SiO2 layer 210, instead of as a continuous layer with a rib as illustrated in FIG. 2A. In some aspects, a rib structure can provide simpler fabrication with less etching of the AlScN piezoelectric layer, while a ridge structure can provide improved confinement of the light (e.g., TM optical modes) and associated lower optical losses with higher modulation efficiency. In some aspects, devices in accordance with aspects described herein can operate with transverse magnetic TM waveguide modes. In other aspects, devices can operate using transverse electric (TE) waveguide modes.

In various aspects, such a selection may be based on the performance targets of a device. Just as in FIG. 2A, in FIG. 2D, the signal line 202 and the reference 201 are configured to generate electrical field aligned with the axis 214 of the AlScN piezoelectric layer 210 to cause modulation of light in the ridge waveguide area 212. The axis 214 and other axis labels or references described herein can refer to the c-axis of a material. A c-axis of a crystalline structure is an axis parallel to a longest direction between sides of the basic crystalline structure. AlScN features a wurtzite structure, where the c-axis of the material is oriented perpendicular to the wafer surface (z-direction). Its main piezoelectric and nonlinear susceptibility is measured along the c-axis of the material. The nonlinear susceptibility is related to the electro-optic coefficient. In such a structure, the largest electro-optic effect, and performance benefit of AlScN is observed when the c-axis and the fields are aligned in z-direction. In some aspects, such a benefit occurs with a structure and alignments of an AlScN c-axis, an externally applied electric field, and electric field of the optical wave. This structure can use a TM optical mode.

In either configuration, an AlScN electro-optical modulator 106 provides effective mode confinement to the waveguide, efficient modulation (e.g., and associated compact device size) due to the large electro-optic coefficient of AlScN, and an ability to efficiently form the AlScN piezoelectric layer directly without a need for grinding or cutting a crystalline wafer to adjust the axis.

As illustrated above, in both the rib and ridge waveguide implementations, the piezoelectric layer (e.g., AlScN) can function as a waveguide and as a modulation material. For example, in FIGS. 2B and 2E, the piezoelectric layer is structured as an input waveguide and an output waveguide for the AlScN electro-optical modulator 106 in the section of the piezoelectric layer with the conductive layers on each side. By contrast, in FIGS. 2C and 2F, external waveguides 203 and 204 are present and connected to the AlScN modulator via optical interconnects.

FIG. 3A is an isometric perspective of aspects of optical interconnects (e.g., the optical interconnects 102 and 108) including a first interconnect between a light source (e.g., the light source 101) and an electro-optical modulator (e.g., the electro-optical modulator 106) in accordance with aspects described herein, and a second interconnect at the output of the electro-optical modulator. As illustrated in FIG. 3A, the optical interconnect 102 includes an input waveguide 301 formed in or disposed on a substrate 330. The substrate 330 can be a shared Si substrate with an electro-optical modulator, such as the substrate 230 illustrated in FIGS. 2A and 2D. The optical interconnect 102 additionally illustrates an SiO2 layer 320 disposed on the substrate 330, and conductive layers 311 (e.g., a signal layer and a reference or ground layer) on opposite sides of a piezoelectric layer 310. As described above, the conductive layers can be any conductive material appropriate for a given integrated device, such as any material used for signal or metallization layers in a device (e.g., aluminum, etc.). The illustrated structure of the optical interconnect 102 is an inverted taper structure, similar to an interconnect used with similar piezoelectric LN modulators. The optical interconnection 108 can include a similar structure for coupling light from an output of an electro-optical modulator into an output waveguide 308.

FIG. 3B is a top-down perspective of aspects of the optical interconnect 102 between a light source (e.g., the light source 101) and an electro-optical modulator (e.g., the electro-optical modulator 106) in accordance with aspects described herein. FIG. 3C is a side-view perspective of aspects of the optical interconnect 102 between a (e.g., the light source 101) and an electro-optical modulator (e.g., the electro-optical modulator 106) in accordance with aspects described herein. The illustrated reference axis for FIGS. 3A, 3B, and 3C is a shared reference axis with FIGS. 2A and 2D. FIG. 3B is a top view along a z-direction, with the input waveguide 301 and the piezoelectric layer 310 in different z layers (e.g., different x-y planes) shown to overlap from the illustrated perspective with the SiO2 layer 320 removed to show the relative positions from the illustrated perspective. As illustrated, the input waveguide 301 overlaps a first end of the piezoelectric layer (e.g., an end of a waveguide section such as an end of the ridge waveguide area 212 or an end of the rib waveguide area 211) to allow coupling of light. FIG. 3C is a side view from an x direction showing a z-y plane, and illustrating optical coupling from the input waveguide 301 to the piezoelectric layer 310. The perspective of FIGS. 2A and 2D are x-z planes perpendicular to the perspectives of FIGS. 3B and 3C, with the perspectives of FIGS. 2A and 2D similar (e.g., parallel) to the illustrated x-z rectangles shown in FIG. 3A, but further along the piezoelectric layer 310 where the signal line is present to modulate the light in the piezoelectric layer.

As illustrated in FIG. 3C, light from a light source (e.g., the light source 101) is present in the input waveguide 301, and couples to the piezoelectric layer 310. The continuous wave light coupled into the piezoelectric layer 310 then travels along a waveguide section of the piezoelectric layer 310 (e.g., the rib waveguide area 211 or the ridge waveguide area 212) to a section that includes conductive layers 311 around the piezoelectric layer 310 (e.g., a signal line and a reference such as the signal line 202 and the reference 201). If a signal is present on the signal line, the electro-optic effect associated with the axis of the AlScN piezoelectric layer causes polarization of the waveguide area, modulating the light. The modulated light can then be coupled from the piezoelectric waveguide to an output transmission medium via another optical interconnect (e.g., the optical interconnect 108). In FIG. 3C, the signal is illustrated as being on an opposite side of the substrate 330 from the piezoelectric layer, and the ground on a same side as the substrate 330. In other aspects, the signal and ground connections can be reversed, with the signal on the conductive layer between the piezoelectric layer 310 and the substrate 330.

Additionally, as described above, an increased performance is achieved with an alignment of an AlScN c-axis, the externally applied electric field across conductive layers, and an electric field of the optical wave. This alignment as illustrated is achieved when the input light to the waveguide in the piezoelectric layer is in a TM mode in the various aspects above (e.g., resulting in the c-axis, electrical field between conductive layers, and optical TM mode alignment).

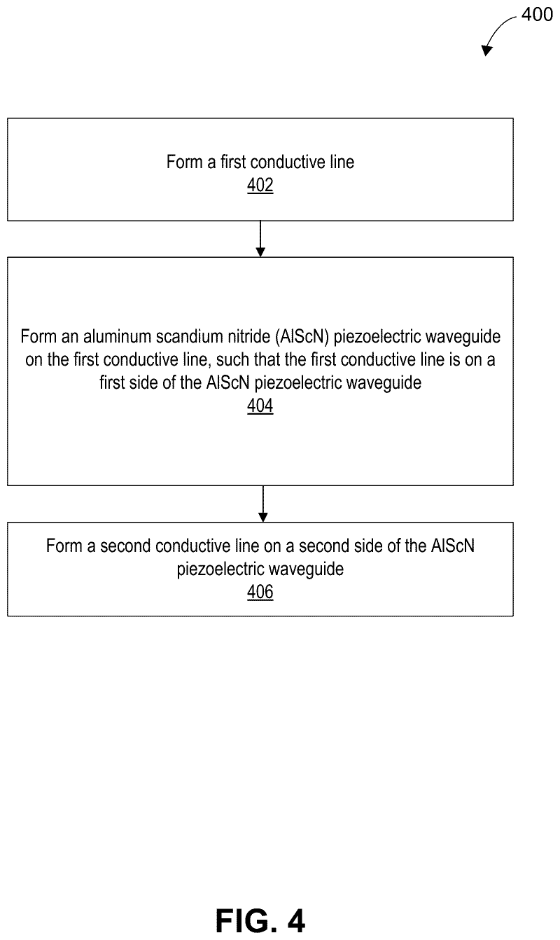

FIG. 4 is a block diagram illustrating a method 400 of manufacturing an electro-optical modulator in accordance with aspects described herein. The method 400 includes block 402, which describes forming a first conductive line (e.g., the reference 201 node or a conductive line of the conductive layer 311). The method 400 further includes block 404, which describes forming an aluminum scandium nitride (AlScN) piezoelectric waveguide, where the first conductive line is on a first side of the AlScN piezoelectric waveguide, and wherein the AlScN piezoelectric waveguide has a c-axis. As described above, the AlScN piezoelectric waveguide can be formed in a layer of AlScN where the AlScN piezoelectric waveguide is formed of a layer comprising Al(1−x)Sc(x)N, where x=0.01*n, n is any real number from 0 through 45 (e.g., an integer or other real number in decimal form), inclusive, and x can include multiples of 0.01, such as from 0 through 45 (e.g., to cover all possible AlScN compositions 0≤x<0.45 where the material is AlN when x=0). The method 400 includes block 406, which describes forming a second conductive line on a second side of the AlScN piezoelectric waveguide. In various aspects, the first conductive line, the second conductive line, and the AlScN piezoelectric waveguide are positioned such that the c-axis is aligned to be parallel with an electrical field generated by an electrical potential between the first conductive line and the second conductive line. In some aspects, the method 400 further involves manufacturing an optical interconnect or AlScN waveguide input and output configured for a TM optical mode, such that the TM optical mode aligns with the c-axis and the electrical field.

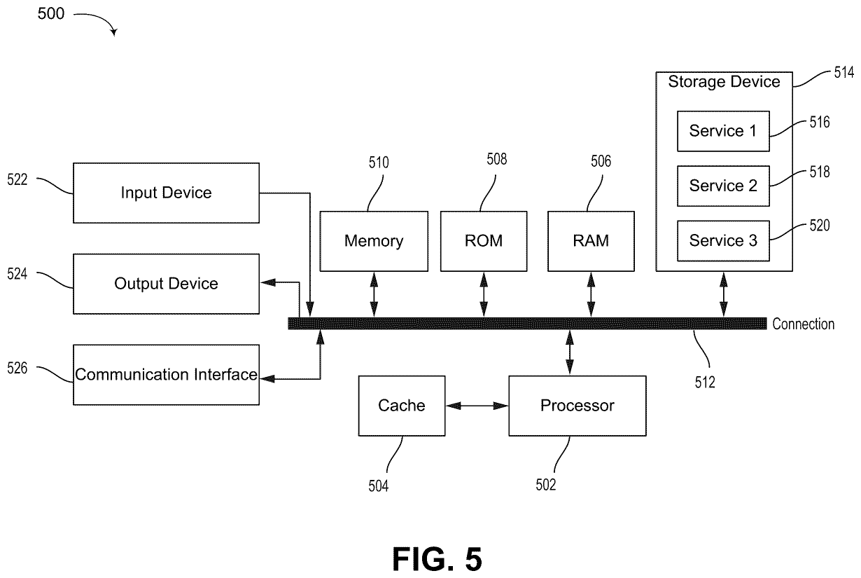

FIG. 5 illustrates an example computing-device architecture 500 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the communication interface 526 of the computing-device architecture 500 may include implementations of the electro-optical modulators 106A/106B or any implementation of an electro-optical modulator in accordance with aspects described herein. Additionally, the computing-device architecture 500 can include any number of output devices 524 or elements of the communication interface 526, or integration of other devices or elements that include electro-optical modulators as described herein.

The components of computing-device architecture 500 are shown in electrical communication with each other using connection 512, such as a bus. The example computing-device architecture 500 includes a processing unit (CPU or processor) 502 and computing device connection 512 that couples various computing device components including computing device memory 510, such as read only memory (ROM) 508 and random-access memory (RAM) 506, to processor 502.

Computing-device architecture 500 can include a cache of high-speed memory connected directly with, in close proximity to, or integrated as part of processor 502. Computing-device architecture 500 can copy data from memory 510 and/or the storage device 514 to cache 504 for quick access by processor 502. In this way, the cache can provide a performance boost that avoids processor 502 delays while waiting for data. These and other modules can control or be configured to control processor 502 to perform various actions. Other computing device memory 510 may be available for use as well. Memory 510 can include multiple different types of memory with different performance characteristics. Processor 502 can include any general-purpose processor and a hardware or software service, such as service 1 516, service 2 518, and service 3 520 stored in storage device 514, configured to control processor 502 as well as a special-purpose processor where software instructions are incorporated into the processor design. Processor 502 may be a self-contained system, containing multiple cores or processors, a bus, memory controller, cache, etc. A multi-core processor may be symmetric or asymmetric.

To enable user interaction with the computing-device architecture 500, input device 522 can represent any number of input mechanisms, such as a microphone for speech, a touch-sensitive screen for gesture or graphical input, keyboard, mouse, motion input, speech and so forth. Output device 524 can also be one or more of a number of output mechanisms known to those of skill in the art, such as a display, projector, television, speaker device, etc. In some aspects, the interfaces for such devices can include the use of an electro-optical modulator to communicate data in accordance with aspects described herein. In some instances, multimodal computing devices can enable a user to provide multiple types of input to communicate with computing-device architecture 500. Communication interface 526 can generally govern and manage the user input and computing device output, and can use electro-optical modulators to encode data for communication via the communication interface 526. There is no restriction on operating on any particular hardware arrangement and therefore the basic features here may easily be substituted for improved hardware or firmware arrangements as they are developed.

Storage device 514 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 506, read only memory (ROM) 508, and hybrids thereof. Storage device 514 can include services 516, 518, and 520 for controlling processor 502. Other hardware or software modules are contemplated. Storage device 514 can be connected to the computing device connection 512. In one aspect, a hardware module that performs a particular function can include the software component stored in a computer-readable medium in connection with the necessary hardware components, such as processor 502, connection 512, output device 524, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. In some aspects, light detection and ranging (LiDAR) functionality of any such device can be implemented using aspects described herein. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), Flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration). Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus comprising: an optical waveguide comprising aluminum scandium nitride (AlScN) formed with piezoelectric layer having an axis from a first side of the optical waveguide to a second side of the optical waveguide; an electrical signal line formed on the first side of the optical waveguide; and a reference node formed on the second side of the optical waveguide.

Aspect 2. The apparatus of Aspect 1, wherein the optical waveguide is disposed on a first silicon oxide (SiO2) layer, and wherein the reference node is disposed in the first SiO2 layer.

Aspect 3. The apparatus of Aspect 2, wherein the optical waveguide is a rib waveguide formed from the AlScN of the piezoelectric layer.

Aspect 4. The apparatus of Aspect 3, further comprising a second SiO2 layer disposed on the piezoelectric layer; wherein the electrical signal line is disposed on the second SiO2 layer.

Aspect 5. The apparatus of Aspect 4, further comprising a silicon substrate, wherein the first SiO2 layer is disposed on the silicon substrate.

Aspect 6. The apparatus of Aspect 5, further comprising an input waveguide disposed on the silicon substrate, wherein the input waveguide is positioned to overlap a first end of the optical waveguide for optical coupling from the input waveguide to the first end of the optical waveguide.

Aspect 7. The apparatus of Aspect 6, further comprising a light source having an output coupled to the input waveguide, wherein the light source generates a continuous wave light output.

Aspect 8. The apparatus of any one of Aspects 1 to 7, further comprising an output waveguide positioned to accept a modulated light signal from a second end of the optical waveguide.

Aspect 9. The apparatus of any one of Aspects 1 to 8, further comprising signal generation circuitry coupled to the electrical signal line.

Aspect 10. The apparatus of Aspect 9, further comprising a memory and one or more processors coupled to the memory, wherein the one or more processors are configured to provide data from the memory to the signal generation circuitry.

Aspect 11. The apparatus of Aspect 10, wherein the signal generation circuitry is configured to provide an electrical signal modulated at radio frequencies or microwave frequencies for modulation of light in the optical waveguide based on an orientation of the axis and an electrical field from the electrical signal line across the optical waveguide.

Aspect 12. The apparatus of any one of Aspects 2 to 11, wherein the optical waveguide is a ridge waveguide formed from the AlScN of the piezoelectric layer.

Aspect 13. The apparatus of Aspect 12, further comprising a second SiO2 layer disposed on the piezoelectric layer and the first SiO2 layer.

Aspect 14. The apparatus of any one of Aspects 12 or 13, wherein the ridge waveguide is a trapezoidal waveguide formed in the first SiO2 layer.

Aspect 15. The apparatus of Aspect 14, further comprising a silicon substrate, wherein the first SiO2 layer is disposed on the silicon substrate.

Aspect 16. The apparatus of Aspect 15, further comprising a tapered input waveguide disposed on the silicon substrate, wherein the tapered input waveguide is positioned to overlap a first end of the optical waveguide for optical coupling from the tapered input waveguide to the first end of the optical waveguide.

Aspect 17. The apparatus of Aspect 16, further comprising a light source having an output coupled to the tapered input waveguide, wherein the light source generates a continuous wave light output.

Aspect 18. An apparatus comprising: an aluminum scandium nitride (AlScN) piezoelectric waveguide having a c-axis; an electrical signal line formed on a first side of the

AlScN piezoelectric waveguide; and a reference node formed on a second side of the AlScN piezoelectric waveguide; wherein the c-axis is aligned from the electrical signal line to the reference node.

Aspect 19. A method of fabricating layers of an electro-optical modulator to achieve any apparatus of Aspects 1-18 above.

Aspect 20. A method comprising: generating a communication signal; inputting continuous wave light to a first end of an optical waveguide; and modulating the continuous wave light in the optical waveguide by providing the communication signal to an electrical signal line formed on a first side of the optical waveguide, wherein the optical waveguide comprises aluminum scandium nitride (AlScN) formed in piezoelectric layer having a c-axis from a first side of the optical waveguide to a second side of the optical waveguide, wherein the electrical signal line is formed on the first side of the optical waveguide, and wherein a reference node formed on a second side of the optical waveguide such that an electrical field generated by the communication signal from the electrical signal line to the reference node is aligned with the c-axis.

Aspect 21. The method of Aspect 20, wherein the continuous wave light is TM polarized light, such that an electrical field of the continuous wave light, the c-axis, and an electrical field from the electrical signal line to the reference node are all aligned.

Aspect 22. A method comprising: forming a waveguide comprising aluminum scandium nitride (AlScN) formed with piezoelectric layer having a c-axis from a first side of the optical waveguide to a second side of the optical waveguide; forming an electrical signal line on the first side of the optical waveguide; and forming a reference node formed on the second side of the optical waveguide.

Aspect 23. The method of Aspect 22, further comprising forming a first silicon oxide (SiO2) layer, wherein the optical waveguide is disposed on a first SiO2 layer, and wherein the reference node is disposed in the first SiO2 layer.

Aspect 24. The method of any one of Aspects 22 or 23, wherein the optical waveguide is a rib waveguide formed from the AlScN of the piezoelectric layer.

Aspect 25. The method of any one of Aspects 22 to 24, further comprising forming a second SiO2 layer disposed on the piezoelectric layer; wherein the electrical signal line is disposed on the second SiO2 layer.

Aspect 26. A method of fabricating an electro-optical modulator comprising: forming a first conductive line; forming an aluminum scandium nitride (AlScN) piezoelectric waveguide having a c-axis on the first conductive line, such that the first conductive line is on a first side of the AlScN piezoelectric waveguide; and forming a second conductive line on a second side of the AlScN piezoelectric waveguide, wherein the first conductive line, the second conductive line, and the AlScN piezoelectric waveguide are positioned such that the c-axis is aligned to be parallel with an electrical field generated by an electrical potential between the first conductive line and the second conductive line.

Aspect 27. The method of any aspect above, wherein the AlScN piezoelectric waveguide or AlScN piezoelectric layer is formed of a layer comprising Al(1−x)Sc(x)N, where x=0.01*n, and n is a real number from 0 through 45, inclusive.

What is claimed is:

1. An apparatus comprising:
an optical waveguide including a piezoelectric layer comprising aluminum scandium nitride (AlScN), the piezoelectric layer having an axis from a first side of the optical waveguide to a second side of the optical waveguide;
an electrical signal line formed on the first side of the optical waveguide; and
a reference node formed on the second side of the optical waveguide.

2. The apparatus of claim 1, wherein the optical waveguide is disposed on a first silicon oxide (SiO₂) layer, and wherein the reference node is disposed in the first SiO₂ layer.

3. The apparatus of claim 2, wherein the optical waveguide is a rib waveguide formed from the AlScN of the piezoelectric layer.

4. The apparatus of claim 3, further comprising a second SiO₂ layer disposed on the piezoelectric layer;
wherein the electrical signal line is disposed on the second SiO₂ layer.

5. The apparatus of claim 4, further comprising a silicon substrate, wherein the first SiO₂ layer is disposed on the silicon substrate.

6. The apparatus of claim 5, further comprising an input waveguide disposed on the silicon substrate, wherein the input waveguide is positioned to overlap a first end of the optical waveguide for optical coupling from the input waveguide to the first end of the optical waveguide.

7. The apparatus of claim 6, further comprising a light source having an output coupled to the input waveguide.

8. The apparatus of claim 1, further comprising an output waveguide positioned to accept a modulated light signal from a second end of the optical waveguide.

9. The apparatus of claim 1, further comprising:
signal generation circuitry coupled to the electrical signal line; and
a memory and one or more processors coupled to the memory, wherein the one or more processors are configured to provide data from the memory to the signal generation circuitry.

10. The apparatus of claim 9, wherein the signal generation circuitry is configured to provide an electrical signal modulated at radio frequencies or microwave frequencies for modulation of light in the optical waveguide.

11. The apparatus of claim 2, wherein the optical waveguide is a ridge waveguide formed from the AlScN of the piezoelectric layer.

12. The apparatus of claim 11, further comprising a second SiO₂ layer disposed on the piezoelectric layer and the first SiO₂ layer.

13. The apparatus of claim 11, wherein the ridge waveguide is a trapezoidal waveguide formed in the first SiO₂ layer.

14. The apparatus of claim 13, further comprising a silicon substrate, wherein the first SiO₂ layer is disposed on the silicon substrate.

15. The apparatus of claim 14, further comprising a tapered input waveguide disposed on the silicon substrate, wherein the tapered input waveguide is positioned to overlap a first end of the optical waveguide for optical coupling from the tapered input waveguide to the first end of the optical waveguide.

16. The apparatus of claim 15, further comprising a light source having an output coupled to the tapered input waveguide.

17. An apparatus comprising:
an aluminum scandium nitride (AlScN) piezoelectric waveguide having a c-axis;
an electrical signal line formed on a first side of the AlScN piezoelectric waveguide; and
a reference node formed on a second side of the AlScN piezoelectric waveguide;
wherein the c-axis is aligned from the electrical signal line to the reference node.

18. The apparatus of claim 17, further comprising signal generation circuitry coupled to the electrical signal line.

19. A method of fabricating an electro-optical modulator comprising:
forming a first conductive line;
forming an aluminum scandium nitride (AlScN) piezoelectric waveguide, wherein the first conductive line is on a first side of the AlScN piezoelectric waveguide, and wherein the AlScN piezoelectric waveguide has a c-axis; and
forming a second conductive line on a second side of the AlScN piezoelectric waveguide, wherein the first conductive line, the second conductive line, and the AlScN piezoelectric waveguide are positioned such that the c-axis is aligned to be parallel with an electrical field generated by an electrical potential between the first conductive line and the second conductive line.

20. The method of claim 19, wherein the AlScN piezoelectric waveguide is formed of a layer comprising Al(1−x)Sc(x)N, where x=0.01*n, and n is a real number from 0 through 45, inclusive.
